(19) United States
(12) Patent Application Publication
(10) Pub. No.: US 2014/0363059 A1
(43) Pub. Date: Dec. 11, 2014

(54) RETAIL CUSTOMER SERVICE INTERACTION SYSTEM AND METHOD

(71) Applicant: Matthew Hurewitz, Hemet, CA (US)

(72) Inventor: Matthew Hurewitz, Hemet, CA (US)

(73) Assignee: BBY SOLUTIONS, INC., Richfield, MN (US)

(21) Appl. No.: 14/031,113

(22) Filed: Sep. 19, 2013

Related U.S. Application Data
(63) Continuation-in-part of application No. 13/912,784, filed on Jun. 7, 2013.

(51) Int. Cl. G06Q 30/02; G06K 9/00

(52) U.S. Cl. CPC G06Q 30/0201; G06K 9/00221
USPC 382/118

(57) ABSTRACT

A retail store is provided with both physical retail products and a virtual interactive product display. A system is provided that monitors a customer's movements, product interactions, and purchase behavior while looking at both physical items and while using the virtual interactive product display. Emotional reactions to physical items and the virtual display are also tracked. User movement through the physical store is tracked using sensors placed throughout the store. Profiles of this movement are created anonymously, and then associated with known customer identities on the occurrence of an identification event. In-store, on-line, and virtual customer data are combined to create a comprehensive customer data store. A retail clerk uses smart eyewear to select a customer and request identification. Upon identification, a subset of the data store is downloaded for viewing through the smart eyewear to increase the effectiveness of the clerk when assisting the customer.

### RELATED APPLICATIONS

The present application is a continuation-in-part application of U.S. patent application Ser. No. 13/912,784 filed on Jun. 7, 2013.

### FIELD OF THE INVENTION

The present application relates to the field of tracking customer behavior in a retail environment. More particularly, the described embodiments relate to a system and method for tracking customer behavior in a retail store, combining such data with data obtained from customer behavior in an online environment, and presenting such combined data to a retail store employee in a real-time interaction with the customer.

### SUMMARY

One embodiment of the present invention provides an improved system for selling retail products in a physical retail store. The system replaces some physical products in the retail store with three-dimensional (3D) rendered images of the products for sale. The described system and methods allow a retailer to offer a large number of products for sale without requiring the retailer to increase the amount of retail floor space devoted to physical products.

Another embodiment of the present invention tracks customer movement and product interaction within a physical retail store. A plurality of sensors are used to track customer location and movement in the store. The sensors can identify customer interaction with a particular product, and in some embodiments can register the emotional reactions of the customer during the product interaction. The sensors may be capable of independently identifying the customer as a known customer in the retail store customer database. Alternatively, the sensors may be capable of tracking the same customer across multiple store visits without linking the customer to the customer database through the use of an anonymous profile. The anonymous profile can be linked to the customer database at a later time through a self-identifying act occurring within the retail store. This act is identified by time and location within the store in order to match the self-identifying act to the anonymous profile. The sensors can distinguish between customers using visual data, such as facial recognition or joint position and kinetics analysis. Alternatively, the sensors can distinguish between customers by analyzing digital signals received from objects carried by the customers.

Another embodiment of the present invention uses smart, wearable devices to provide customer information to store employees. An example of a smart wearable device is smart eyewear. An employee can face a customer and request identification of that customer. The location and view direction of the employee is then used to match that customer to a profile being maintained by the sensors monitoring the movement of the customer within the retail store. Once the customer is matched to a profile, information about the customer's current visit is downloaded to the smart wearable device. If the profile is matched to a customer record, data from previous customer interactions with the retailer can also be downloaded to the wearable device, including major past purchases and status in a retailer loyalty program.

### BRIEF DESCRIPTION OF THE DRAWINGS

FIG. 1 is a schematic diagram of a physical retail store system for analyzing customer shopping patterns.

FIG. 2 is a schematic diagram of a system for providing a virtual interactive product display and tracking in-store and online customer behavior.

FIG. 3 is a schematic diagram of a controller computer for a virtual interactive product display.

FIG. 4 is a schematic of a customer information database server.

FIG. 5 is a schematic diagram of a product database that is used by a product database server.

FIG. 6 is a schematic diagram of a mobile device for use with a virtual interactive product display.

FIG. 7 is a schematic diagram of a store sensor server.

FIG. 8 is a perspective view of retail store customers interacting with a virtual interactive product display.

FIG. 9 is a perspective view of smart eyewear that may be used by a store clerk.

FIG. 10 is a schematic view of the view seen by a store clerk using the smart eyewear while interacting with a customer.

FIG. 11 is a flow chart demonstrating a method for using a virtual interactive product display to analyze customer emotional reaction to retail products for sale.

FIG. 12 is a flow chart demonstrating a method for analyzing shopping data at a virtual interactive product display used by self-identified retail store customers.

FIG. 13 is a flow chart demonstrating a method for collecting customer data analytics for in-store customers.

FIG. 14 is a schematic diagram of customer data available through the system of FIG. 1.

FIG. 15 is a flow chart of a method for downloading customer data to smart eyewear worn by a retail employee.

### DETAILED DESCRIPTION

### Retail Store System 100

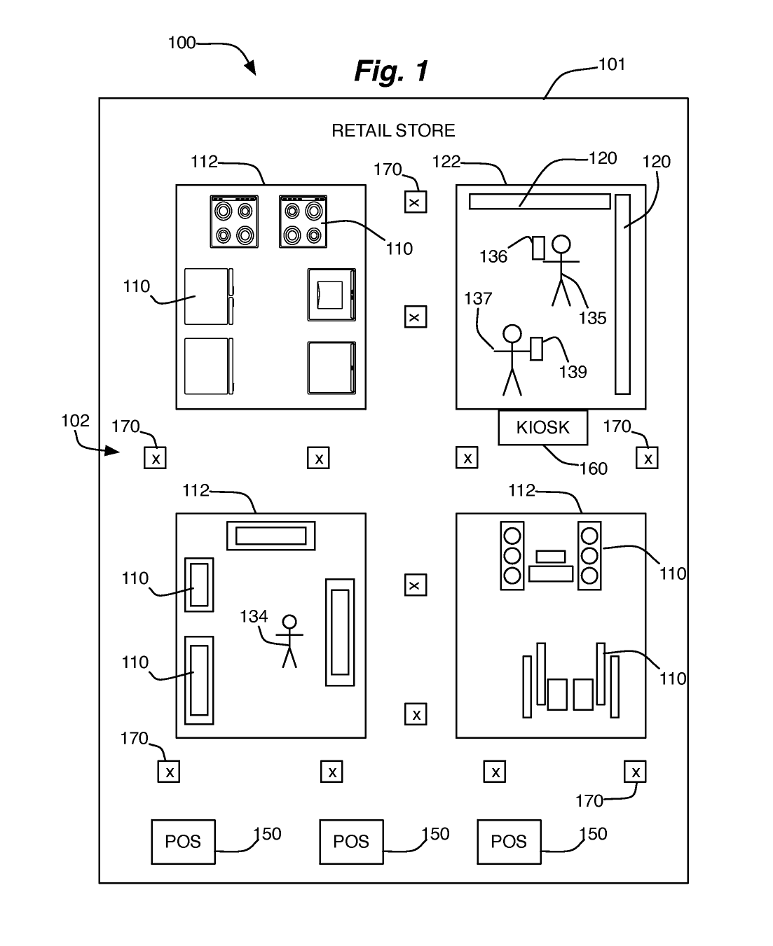

FIG. 1 shows a retail store system 100 including a retail space (i.e., a retail “store”) 101 having both physical retail products 110 and virtual interactive product displays 120. The virtual display 120 allows a retailer to present an increased assortment of products for sale without increasing the footprint of retail space 101. In one embodiment, the retail space 101 will be divided into one or more physical product display floor-spaces 112 for displaying the physical retail products 110 for sale and a virtual display floor-space 122 dedicated to the virtual display 120. In other embodiments, the physical products 110 and virtual displays 120 will be intermixed throughout the retail space 101. The retail store system 100 also includes a customer follow-along system 102 to track customer movement within the retail space 101 and interaction with the physical retail products 110. The system 100 is designed to simultaneously track a virtual display customer 135 interacting with the virtual display 120 and a physical product customer 134 interacting with the physical retail products 110.

A plurality of point-of-sale (POS) terminals 150 within retail store 101 allows customer 134 to purchase physical retail products 110 or order products that the customer 135 viewed on the virtual display 120. A sales clerk 137 may help customers with purchasing physical products 110 and assisting with use of the virtual display 120. In FIG. 1, customer 135 and sales clerk 137 are shown using mobile devices 136 and 139, respectively. The mobile devices 136, 139 may be tablet computers, smartphones, portable media players, laptop computers, or wearable “smart” fashion accessories such as smart watches or smart eyewear. The smart eyewear may be, for example, Google Glass, provided by Google Inc. of Menlo Park, Calif. In one embodiment the sales clerk's device 139 may be a dedicated device for use only with the display 120. These mobile devices 136, 139 may be used to search for and select products to view on display 120 as described in more detail in the incorporated patent application. In addition, the sales clerk 137 may use mobile device 139 to improve their interaction with physical product customers 134 or virtual display customers 135.

In one embodiment the virtual display 120 could be a single 2D- or 3D-TV television screen. However, in a preferred embodiment the display 120 would be implemented as a large-screen display that could, for example, be projected onto an entire wall by a video projector. The display 120 could be a wrap-around screen surrounding a customer 135 on more than one side. The display 120 could also be implemented as a walk-in virtual experience with screens on three sides of the customer 135. The floor of space 122 could also have a display screen, or a video image could be projected onto the floor-space 122.

The display 120 preferably is able to distinguish between multiple users. For a large display screen 120, it is desirable that more than one product could be displayed, and more than one user at a time could interact with the display 120. In one embodiment of a walk-in display 120, 3D sensors would distinguish between multiple users. The users would each be able to manipulate virtual interactive images independently.

A kiosk 160 could be provided to help customer 135 search for products to view on virtual display 120. The kiosk 160 may have a touchscreen user interface that allows customer 135 to select several different products to view on display 120. Products could be displayed one at a time or side-by-side. The kiosk 160 could also be used to create a queue or waitlist if the display 120 is currently in use. In other embodiments, the kiosk 160 could connect the customer 135 with the retailer's e-commerce website, which would allow the customer both to research additional products and to place orders via the website.

### Customer Follow-Along System 102

The customer follow-along system 102 is useful to retailers who wish to understand the traffic patterns of customers 134, 135 around the floor of the retail store 101. To implement the tracking system, the retail space 101 is provided with a plurality of sensors 170. The sensors 170 are provided to detect customers 134, 135 as they visit different parts of the store 101. Each sensor 170 is located at a defined location within the physical store 101, and each sensor 170 is able to track the movement of an individual customer, such as customer 134, throughout the store 101.

The sensors 170 each have a localized sensing zone in which the sensor 170 can detect the presence of customer 134. If the customer 134 moves out of the sensing zone of one sensor 170, the customer 134 will enter the sensing zone of another sensor 170. The system keeps track of the location of customers 134-135 across all sensors 170 within the store 101. In one embodiment, the sensing zones of all of the sensors 170 overlap so that customers 134, 135 can be followed continuously. In an alternative embodiment, the sensing zones for the sensors 170 may not overlap. In this alternative embodiment the customers 134, 135 are detected and tracked only intermittently while moving throughout the store 101.

Sensors 170 may take the form of visual or infrared cameras that view different areas of the retail store space 101. Computers could analyze those images to locate individual customers 134, 135. Sophisticated algorithms on those computers could distinguish between individual customers 134, 135, using techniques such as facial recognition. Motion sensors could also be used that do not create detailed images but track the movement of the human body. Computers analyzing these motion sensors can track the skeletal joints of individuals to uniquely identify one customer 134 from all other customers 135 in the retail store 101. In general, the system 102 tracks the individual 134 based on the physical characteristics of the individual 134 as detected by the sensors 170 and analyzed by system computers. The sensors 170 could be overhead, or in the floor of the retail store 101.

For example, customer 134 may walk into the retail store 101 and will be detected by a first sensor 170, for example a sensor 170 at the store's entrance. The particular customer 134's identity at that point is anonymous, which means that the system 102 cannot associate this customer 134 with identifying information such as the individual's name or a customer ID in a customer database. Nonetheless, the first sensor 170 may be able to identify unique characteristics about this customer 134, such as facial characteristics or skeletal joint locations and kinetics. As the customer 134 moves about the retail store 101, the customer 134 leaves the sensing zone of the first sensor 170 and enters a second zone of a second sensor 170. Each sensor 170 that detects the customer 134 provides information about the path that the customer 134 followed throughout the store 101. Although different sensors 170 are detecting the customer 134, computers can track the customer 134 moving from sensor 170 to sensor 170 to ensure that the data from the multiple sensors are associated with a single individual.

Location data for the customer 134 from each sensor is aggregated to determine the path that the customer 134 took through the store 101. The system 102 may also track which physical products 110 the customer 134 viewed, and which products were viewed as images on a virtual display 120. A heat map of store shopping interactions can be provided for a single customer 134, or for many customers 134, 135. The heat maps can be strategically used to decide where to place physical products 110 on the retail floor, and which products should be displayed most prominently for optimal sales.

If the customer 134 leaves the store 101 without self-identifying or making a purchase, and if the sensors 170 were unable to independently associate the customer 134 with a known customer in the store's customer database, the tracking data for that customer 134 may be stored and analyzed as anonymous tracking data (or an “anonymous profile”). When the same customer 134 returns to the store, it may be that the sensors 170 and the sensor analysis computers can identify the customer 134 as the same customer tracked during the previous visit. With this ability, it is possible to track the same customer 134 through multiple visits even if the customer 134 has not been associated with personal identifying information (e.g., their name, address, or customer ID number).

If during a later visit the customer 134 chooses to self-identify at any point in the store 101, the customer 134's previous movements around the store can be retroactively associated with the customer 134. For example, if a customer 134 enters the store 101 and is tracked by sensors 170 within the store, the tracking information is initially anonymous. However, if during a subsequent visit (or later during the same visit) the customer 134 chooses to self-identify, for example by entering a customer ID into the virtual display 120, or providing a loyalty card number when making a purchase at POS 150, the previously anonymous tracking data can be assigned to that customer ID. Information, including which stores 101 the customer 134 visited and which products 110 the customer 134 viewed, can be used with the described methods to provide deals, rewards, and incentives to the customer 134 to personalize the customer 134's retail shopping experience.

### Customer Emotional Reaction Analysis

In one embodiment of the virtual interactive product display 120, the sensors built into the display 120 can be used to analyze a customer's emotional reaction to 3D images on the display screen. Motion sensors or video cameras may record a customer's skeletal joint movement or facial expressions, and use that information to extrapolate how the customer felt about the particular feature of the product. The sensors may detect anatomical parameters such as a customer's gaze, posture, facial expression, skeletal joint movements, and relative body position. The particular part of the product image to which the customer reacts negatively can be determined either by identifying where the customer's gaze is pointed, or by determining which part of the 3D image the user was interacting with while the customer slouched.

These inputs can be fed into computer-implemented algorithms to classify customer emotive response to image manipulation on the display screen. For example, the algorithms may determine that a change in the joint position of a customer's shoulders indicates that the customer is slouching and is having a negative reaction to a particular product. Facial expression revealing a customer's emotions could also be detected by a video camera and associated with the part of the image that the customer was interacting with. Both facial expression and joint movement could be analyzed together by the algorithms to verify that the interpretation of the customer emotion is accurate. These algorithms may be supervised or unsupervised machine learning algorithms, and may use logistic regression or neural networks.

This emotional reaction data can be provided to a product manufacturer as aggregated information. The manufacturer may use the emotion information to design future products. The emotional reaction data can also be used by the retail store to select products for inventory that trigger positive reactions and remove products that provoke negative reactions. The retail store could also use this data to identify product features and product categories that cause confusion or frustration for customers, and then provide greater support and information for those features and products.

Skeletal joint information and facial feature information can also be used to generally predict anonymous demographic data for customers interacting with the virtual product display. The demographic data, such as gender and age, can be associated with the customer emotional reaction to further analyze customer response to products. For example, gesture interactions with 3D images may produce different emotional responses in children than in adults.

A heat map of customer emotional reaction may be created from an aggregation of the emotional reaction of many different customers to a single product image. Such a heat map may be provided to the product manufacturer to help the manufacturer improve future products. The heat map could also be utilized to determine the types of gesture interactions that customers prefer to use with the 3D rendered images. This information would allow the virtual interactive display to present the most pleasing user interaction experience with the display.

Similarly, sensors 170 located near the physical products 110 can also track and record the customer's emotional reaction to the physical products 110. Because the customer's location within the retail store 101 is known by the sensor's 170, emotional reactions can be tied to products 110 that are found at that location and are being viewed by the customer 134. In this embodiment, the physical products 110 can be found at known location in the store. One or more sensors 170 identify the product 110 that the customer 135 was interacting with, and detect the customer 135's anatomical parameters such as skeletal joint movement or facial expression. In this way, product interaction data would be collected for the physical products 110, and the interaction data would be aggregated and used to determine the emotions of the customer 134.

### Information System 200

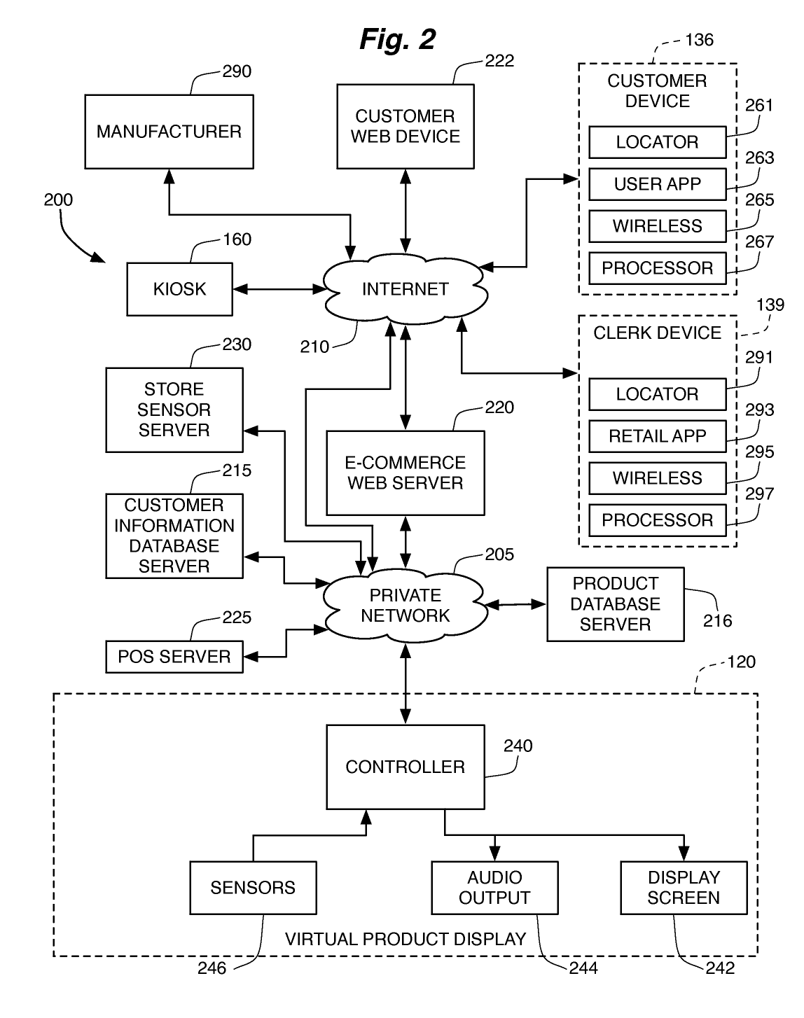

FIG. 2 shows an information system 200 that may be used in the retail store system 100. The various components in the system 200 are connected to one of two networks 205, 210. A private network 205 connects the virtual product display 120 with servers 215, 216, 220, 225, 230 operated by and for the retailer. This private network may be a local area network, but in the preferred embodiment this network 205 allows servers 215, 216, 220, 225, 230 and retail stores 101 to share data across the country and around the world. A public wide area network (such as the Internet 210) connects these display 120 and servers 215, 216, 220, 225, 230 with third-party computing devices. In an actual implementation, the private network 205 may transport traffic over the Internet 210. FIG. 2 shows these networks 205, 210 separately because each network perform a different logical function, even though the two networks 205, 210 may be merged into a single physical network in practice. It is to be understood that the architecture of system 200 as shown in FIG. 2 is an exemplary embodiment, and the system architecture could be implemented in many different ways.

The virtual product display 120 is connected to the private network 205, giving it access to a customer information database server 215 and a product database server 216. The customer database server 215 maintains a database of information about customers who shop in the retail store 101 (as detected by the sensors 170 and the store sensor server 230), who purchase items at the retail store (as determined by the POS server 225), who utilize the virtual product display 120, and who browse products and make purchases over the retailer's e-commerce web server 220. In one embodiment, the customer database server 215 assigns each customer a unique identifier (“user ID”) linked to personally-identifying information and purchase history for that customer. The user ID may be linked to a user account, such as a credit line or store shopping rewards account.

The product database server 216 maintains a database of products for sale by the retailer. The database includes 3D rendered images of the products that may be used by the virtual product display 120 to present the products to customers. The product database server 216 links these images to product information for the product. Product information may include product name, manufacturer, category, description, price, local-store inventory info, online availability, and an identifier (“product ID”) for each product. The database maintained by server 216 is searchable by the customer mobile device 136, the clerk mobile device 139, the kiosk 160, the e-commerce web server 220, other customer web devices (such as a computer web browser) 222 accessing the web server 220, and through the virtual product display 120. Note that some of these searches originate over the Internet 210, while other searches originate over a private network 205 maintained by the retailer.

Relevant information obtained by the system in the retail store can be passed back to web server 220, to be re-render for the shopper's convenience, at a later time, on a website, mobile device, or other customer facing view. An example of this embodiment includes a wish list or sending product information to another stakeholder in the purchase (or person of influence).

The point of sale (POS) server 225 handles sales transactions for the point of sale terminals 105 in the retail store site 101. The POS server 225 can communicate sales transactions for goods and services sold at the retail store 101, and related customer information to the retailer's other servers 215, 216, 220, 230 over the private network 205.

As shown in FIG. 2, the display 120 includes a controller 240, a display screen 242, audio speaker output 244, and visual and non-visual sensors 246. The sensors 246 could include video cameras, still cameras, motion sensors, 3D depth sensors, heat sensors, light sensors, audio microphones, etc. The sensors 246 provide a mechanism by which a customer 135 can interact with virtual 3D product images on display screen 242 using natural gesture interactions.

A “gesture” gesture is generally considered to be a body movement that constitutes a command for a computer to perform an action. In the system 200, sensors 246 capture raw data relating to motion, heat, light, or sound, etc. created by a customer 135 or clerk 137. The raw sensor data is analyzed and interpreted by a computer—in this case the controller 240. A gesture may be defined as one or more raw data points being tracked between one or more locations in one-, two-, or three-dimensional space (e.g., in the (x, y, z) axes) over a period of time. As used herein, a “gesture” could also include an audio capture such as a voice command, or a data input received by sensors, such as facial recognition. Many different types of natural-gesture computer interactions will be known to one of ordinary skill in the art. For example, such gesture interactions are described in U.S. Pat. No. 8,213,680 (Proxy training data for human body tracking) and U.S. patent application publications US 20120117514 A1 (Three-Dimensional User Interaction) and US 20120214594 A1 (Motion recognition), all assigned to Microsoft Corporation, Redmond, Wash.

The controller computer 240 receives gesture data from the sensors 246 and converts the gestures to inputs to be performed. The controller 240 also receives 3D image information from the product database server 216 and sends the information to be output on display screen 242. In the embodiment shown in FIG. 2, the controller 240 accesses the customer information database server 215 and the product database server 216 over the private network 205. In other embodiments, these databases could be downloaded directly to the virtual product display 120 to be managed and interpreted directly by the controller 240. In other embodiments, these database servers 215, 216 would be accessed directly over the Internet 210 using a secure communication channel.

As shown in FIG. 2, customer mobile device 136 and sales clerk mobile device 139 each contain software applications or “apps” 263, 293 to search the product database server 216 for products viewable on the interactive display 120. In one embodiment, these apps are specially designed to interact with the virtual product display 120. While a user may be able to search for products directly through the interface of interactive display 120, it is frequently advantageous to allow the customer 135 to select products using the interface of the customer device 136. It would also be advantageous for a store clerk 137 to be able to assist the customer 135 to choose which products to view on the display 120. User app 263 and retailer app 293 allow for increased efficiency in the system 200 by providing a way for customers 135 to pre-select products to view on display 120. Moreover, if need be, mobile device 139 can fully control interactive display 120.

The user app 263 may be a retailer-branded software app that allows the customer 135 to self-identify within the app 263. The customer 135 may self-identify by entering a unique identifier into the app 263. The user identifier may be a loyalty program number for the customer 135, a credit card number, a phone number, an email address, a social media username, or other such unique identifier that uniquely identifies a particular customer 135 within the system 200. The identifier is preferably stored by customer information database server 215 as well as being stored in a physical memory of device 136. In the context of computer data storage, the term “memory” is used synonymously with the word “storage” in this disclosure. If the user does self-identify using the app 263, one embodiment of a sensor 170 is able to query the user's mobile device 136 for this identification.

The app 263 may allow the customer 135 to choose not to self-identify. Anonymous users could be given the ability to search and browse products for sale within app 263. However, far fewer app features would be available to customers 135 who do not self-identify. For example, self-identifying customers would able to make purchases via device 136, create “wish lists” or shopping lists, select communications preferences, write product reviews, receive personalized content, view purchase history, or interact with social media via app 263. Such benefits may not be available to customers who choose to remain anonymous.

The apps 263, 293 constitute programming that is stored on a tangible, non-transitory computer memory (not shown) found within the devices 136, 139. This programming 263, 293 instructs processors 267, 297 how to handle data input and output in order to perform the described functions for the apps. The processors 267, 297 can be a general purpose CPUs, such as those provided by Intel Corporation (Mountain View, Calif.) or Advanced Micro Devices, Inc. (Sunnyvale, Calif.), or preferably mobile specific processors, such as those designed by ARM Holdings (Cambridge, UK). Mobile devices such as devices 136, 139 generally use specific operating systems designed for such devices, such as iOS from Apple Inc. (Cupertino, Calif.) or ANDROID OS from Google Inc. (Menlo Park, Calif.). The operating systems are stored on the non-transitory memory and are used by the processors 267, 297 to provide a user interface, handle communications for the devices 136, 139, and to manage the operation of the apps 263, 293 that are stored on the devices 136, 139. As explained above, the clerk mobile device 139 may be wearable eyewear such as Google Glass, which would still utilize the ANDROID operating system and an ARM Holdings designed processor.

In addition to the apps 263 and 293, devices 136 and 139 of FIG. 2 include wireless communication interfaces 265, 295. The wireless interfaces 265, 295 may communicate with the Internet 210 or the private network 205 via one or more wireless protocols, such as Wi-Fi, cellular data transfer, Bluetooth, infrared, radio frequency, near-field communication (NFC) or other wireless protocols. The wireless interfaces 265, 295 allow the devices 136, 139 to search the product database server 216 remotely through one or both of the network 205, 210. The devices 136, 139 may also send requests the virtual product display that cause the controller 240 to display images on display screen 242.

Devices 136, 139 also preferably include a geographic location indicator 261, 291. The location indicators 261, 291 may be use global positioning system (GPS) tracking, but the indicators 261, 291 may use other methods of determining a location of the devices 136, 139. For example, the device location could be determined by triangulating location via cellular phone towers or Wi-Fi hubs. In an alternative embodiment, locators 261, 291 could be omitted. In this embodiment the system 200 could identify the location of the devices 136, 139 by detecting the presence of wireless signals from wireless interfaces 265, 295 within retail store 101. Alternatively, sensors within the stores could detect wireless communications that emanate from the devices 136, 139. For instance, mobile devices 136, 139 frequently search for Wi-Fi networks automatically, allowing a Wi-Fi network within the retail store environment 101 to identify and locate a mobile device 136, 139 even if the device 136, 139 does not sign onto the Wi-Fi network. Similarly, some mobile devices 136, 139 transmit Bluetooth signal that identify the device and can be detected by sensors in the retail store 101, such as the sensors 170 used in the customer follow-along system 102. Other indoor location tracking technologies known in the prior art could be used to identify the exact location of the devices 136, 139 within a physical retail store environment. The locator devices indicators 261, 291 can supplement the information obtained by the sensors 170 in order to identify and locate both the customers 134, 135 and the store employees 137 within the retail store 101.

In one embodiment, customer 135 and clerk 137 can select pre-select a plurality of products to view on an interactive display 120. The pre-selected products may be a combination of both physical products 110 and products having 3D rendered images in database maintained by server 216. In a preferred embodiment the customer 135 must self-identify in order to save pre-selected products to view at the interactive display 120. The method could also be performed by an anonymous customer 135.

If the product selection is made at a customer mobile device 136, the customer 135 does not need to be within the retail store 101 to choose the products. The method can be performed at any location because the selection is stored on a physical memory, either in a memory on customer device 136, or on a remote memory available via network 210, or both. The product selection may be stored by server 215 in the customer database.

### Controller Computer 240

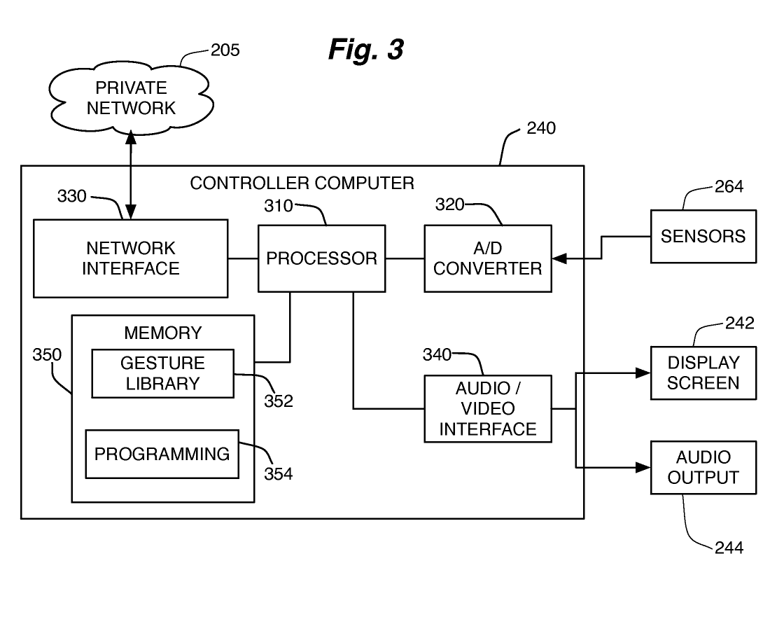

FIG. 3 is a schematic diagram of controller computer 240 that controls the operation of the virtual display 120. The controller 240 includes a computer processor 310 accessing a memory 350. The processor 310 could be a microprocessor manufactured by Intel Corporation of Santa Clara, Calif., or Advanced Micro Devices, Inc. of Sunnyvale, Calif. In one embodiment the memory 350 stores a gesture library 352 and programming 354 to control the functions of display 242. An A/D converter 320 receives sensor data from sensors 246 and relays the data to processor 310. Controller 240 also includes an audio/video interface to send video and audio output to display screen 242 and audio output 244. Processor 310 or A/V interface 340 may include a specialized graphics processing unit (GPU) to handle the processing of the 3D rendered images to be output to display screen 242. A communication interface 330 allows controller 240 to communicate via the network 205. Interface 330 may also include an interface to communicate locally with devices 136, 139, for example through a Wi-Fi, Bluetooth, RFID, or NFC connection, etc. Alternatively, these devices 136, 139 connect to the controller computer via the network 205 and network interface 330. Although the controller computer 240 is shown in FIG. 3 as a single computer with a single processor, the controller 240 could be constructed using multiple processors operating in parallel, or using a network of computers all operating according to the instructions of the computer programming 354. The controller computer 240 may be located at the same retail store 101 as the screen display 242 and be responsible for handling only a single screen 242. Alternatively, the controller computer 240 could handle the processing for multiple screen displays 242 at a single store 101, or even multiple displays 242 found at different store locations 101.

The controller 240 is able to analyze gesture data for customer 135 interaction with 3D rendered images at display 120. In the embodiment shown in FIG. 2, the controller 240 receives data from the product database server 216 and stores the data locally in memory 350. As explained below, this data includes recognized gestures for each product that might be displayed by the virtual product display. Data from the sensors 246 is received A/D converter 320 and analyzed by the processor 310. The sensor data can be used to control the display of images on display screen 242. For example, the gestures seen by the sensors 246 may be instructions to rotate the currently displayed 3D image of a product along a vertical axis. Alternatively, the controller 240 may interpret the sensor data to be passive user feedback to the displayed images as to how customers 135 interact with the 3D rendered images. For example, the server 220 may aggregate a “heat map” of gesture interactions by customers 135 with 3D images on product display 120. A heat map visually depicts the amount of time a user spends interacting with various features of the 3D image. The heat map may use head tracking, eye tracking, or hand tracking to determine which part of the 3D rendered image the customer 135 interacted with the most or least. In another embodiment, the data analysis may include analysis of the user's posture or facial expressions to infer the emotions that the user experienced when interacting with certain parts of the 3D rendered images. The retailer may aggregate analyzed data from the data analysis server and send the data to a manufacturer 290. The manufacturer 290 can then use the data to improve the design of future consumer products. The sensor data received by controller 240 may also include demographic-related data for the customers 134, 135. Demographics such as age and gender can be identified using the sensors 246 of interactive display 120. These demographics can also be used in the data analysis to improve product design and to improve the efficiency and effectiveness of the virtual product display 120.

### Database Servers 215, 216

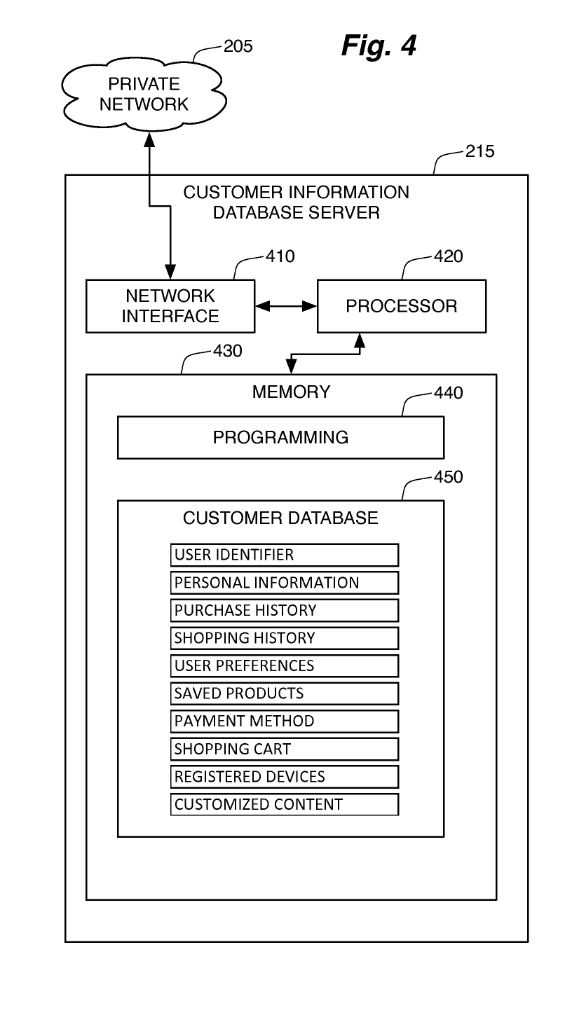

The customer information database server 215 is shown in FIG. 4 as having a network interface 410 that communicates with the private network 205, a processor 420, and a tangible, non-transitory memory 430. As was the case with the controller computer 240, the processor 420 of customer information database server 215 may be a microprocessor manufactured by Intel Corporation of Santa Clara, Calif., or Advanced Micro Devices, Inc. of Sunnyvale, Calif. The network interface 410 is also similar to the network interface 330 of the controller 240. The memory 430 contains programming 440 and a customer information database 450. The programming 440 includes basic operating system programming as well as programming that allows the processor 420 to manage, create, analyze, and update data in the database 450.

The database 450 contains customer-related data that can be stored in pre-defined fields in a database table (or database objects in an object-oriented database environment). The database 450 may include, for each customer, a user ID, personal information such as name and address, on-line shopping history, in-store shopping history, web-browsing history, in-store tracking data, user preferences, saved product lists, a payment method uniquely associated with the customer such as a credit card number or store charge account number, a shopping cart, registered mobile device(s) associated with the customer, and customized content for that user, such as deals, coupons, recommended products, and other content customized based on the user's previous shopping history and purchase history.

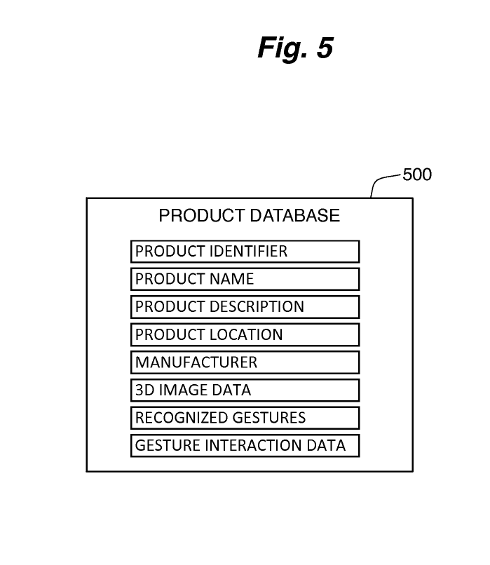

The product database server 216 is constructed similar to the customer information database server 215, with a network interface, a processor, and a memory. The data found in the memory in the product database server 216 is different, however, as this product database 500 contains product related data as is shown in FIG. 5. For each product sold by the retailer, the database 500 may include 3D rendered images of the product, a product identifier, a product name, a product description, product location (such retail stores that have the product in stock, or event the exact location of the product within the retail store 101), a product manufacturer, and gestures that are recognized for the 3D images associated with the product. The product location data may indicate that the particular product is not available in a physical store, and only available to view as an image on a virtual interactive display. Other information associated with products for sale could be included in product database 500 as will be evident to one skilled in the art, including sales price, purchase price, available colors and sizes, related merchandise, etc.

Although the customer information database 450 and the product database 500 are shown being managed by separate server computers in FIGS. 3-5, this is not a mandatory configuration. In alternative embodiments the databases 450, 500 are both resident on the same computer servers. Furthermore, each “server” may be constructed through the use of multiple computers configured to operate together under common programming.

### Mobile Device 600

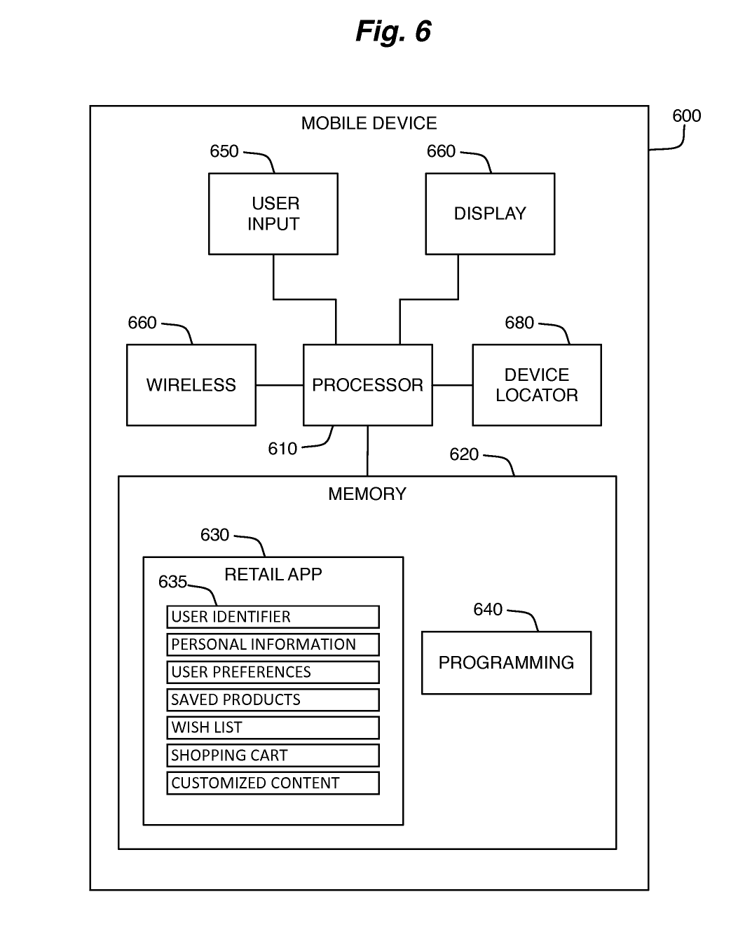

FIG. 6 shows a more detailed schematic of a mobile device 600. The device 600 is a generalized schematic of either of the devices 136, 139. The device 600 includes a processor 610, a device locator 680, a display screen 660, and wireless interface 670. The wireless interface 670 may communicate via one or more wireless protocols, such as Wi-Fi, cellular data transfer, Bluetooth, infrared, radio frequency, near-field communication (NFC) or other wireless protocols. One or more data input interfaces 650 allow the device user to interact with the device. The input may be a keyboard, key pad, capacitive or other touchscreen, voice input control, or another similar input interface allowing the user to input commands.

A retail app 630 and programming logic 640 reside on a memory 620 of device 600. The app 630 allows a user to perform searches of product database 500, select products for viewing on display 120, as well as other functions. In a preferred embodiment, the retail app stores information 635 about the mobile device user. The information 635 includes a user identifier (“user ID”) that uniquely identifies a customer 135. The information 635 also includes personal information such as name and address, user preferences such as favorite store locations and product preferences, saved products for later viewing, a product wish list, a shopping cart, and content customized for the user of device 600. In some embodiments, the information 635 will be retrieved from the user database server 215 over wireless interface 670 and not be stored on memory 620.

### Store Sensor Server 230

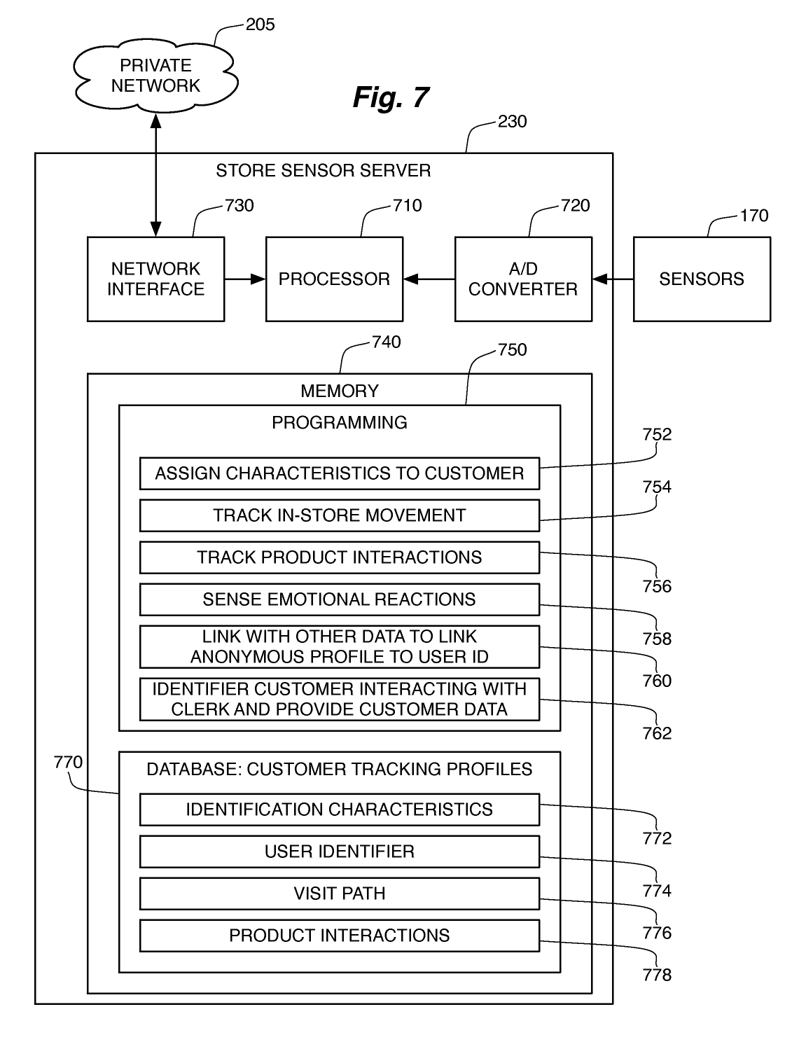

FIG. 7 is a schematic drawing showing the primary elements of a store sensor server 230. The store sensor server 230 is constructed similar to the virtual display controller computer 240, with a processor 710 for operating the server 230, an analog/digital converter 720 for receiving data from the sensors 170, and a network interface 730 to communicate with the private network 205. The store sensor server 230 also has a tangible memory 740 containing both programming 750 and data in the form of a customer tracking profiles database 770.

The store sensor server 230 is designed to receive data from the store sensors 170 and interpret that data. If the sensor data is in analog form, the data is converted into digital form by the A/D converter 720. Sensors 170 that provide data in digital formats will simply bypass the A/D converter 720.

The programming 750 is responsible for ensuring that the processor 710 performs several important processes on the data received from the sensors 170. In particular, programming 752 instructs the processor 710 how to track a single customer 134 based on characteristics received from the sensors 170. The ability to track the customer 134 requires that the processor 710 not only detect the presence of the customer 134, but also assign unique parameters to that customer 134. These parameters allow the store sensor server to distinguish the customer 134 from other customers 135, recognize the customer 134 in the future, and compare the tracked customer 134 to customers that have been previously identified. As explained above, these characteristics may be physical characteristics of the customer 134, or digital data signals received from devices (such as device 136) carried by the customer 134. Once the characteristics are defined by programming 752, they can be compared to characteristics 772 of profiles that already exist in the database 770. If there is a match to an existing profile, the customer 134 identified by programming 752 will be associated with that existing profile in database 770. If no match can be made, a new profile will be created in database 770.

Programming 754 is responsible for instructing the processor 710 to track the customer 134 through the store 101, effectively creating a path for the customer 134 for that visit to the store 101. This path can be stored as data 776 in the database 770. Programming 756 causes the processor 710 to identify when the customer 134 is interacting with a product 110 in the store 101. Interaction may include touching a product, reading an information sheet about the product, or simply looking at the product for a period of time. In the preferred embodiment, the sensors 170 provide enough data about the customer's reaction to the product so that programming 758 can assign an emotional reaction to that interaction. The product interaction and the customer's reaction are then stored in the profile database as data 778.

Programming 760 serves to instruct the store sensor server 230 how to link the tracked movements of a customer 134 (which may be anonymous) to an identified customer in the customer database 450. As explained elsewhere, this linking typically occurs when a user being tracked by sensors 170 identify herself during her visit to the retail store 101, such as by making a purchase with a credit card, using a loyalty club member number, requesting services at, or delivery to, an address associated with the customer 134, or logging into the kiosk 160 or virtual display 120 using a customer identifier. When this happens, the time and location of this event is matched against the visit path of the profiles to identify which customer 134 being tracked has identified herself. When this identification takes place, the user identifier 774 can be added to the customer tracking profile 770.

Finally, programming 762 is responsible for receiving a request from a store clerk 137 to identify a customer 134, 135 within the retail store 101. In one embodiment, the request for identification comes from the clerk device 139, which may take the form of a wearable smart device such as smart eyewear. The programming 762 is responsible for determining the location of the clerk 137 with the store 101, which can be accomplished using the store sensors 170 or the locator 291 within the clerk device 139. In most embodiments, the programming 762 is also responsible for determining the orientation of the clerk 137 (i.e., which direction the clerk is facing). This can be accomplished using orientation sensors (such as a compass) within the clerk device 139, which sends this information to the store sensor server 230 along with the request for customer identification. The location and orientation of the clerk 137 can be used to identify which customers 134, 135 are currently in the clerk's field of view based on the information in the customer tracking profiles database 770. If multiple customers 134, 135 are in the field of view, the store sensor server 230 may select the closest customer 135, or the customer 135 that is most centrally located within the field of view. Once the customer is identified, customer data from the tracking database 770 and the customer database 450 are selectively downloaded to the clerk device 139 to assist the clerk 137 in their interaction with the customer 135.

### Display 120

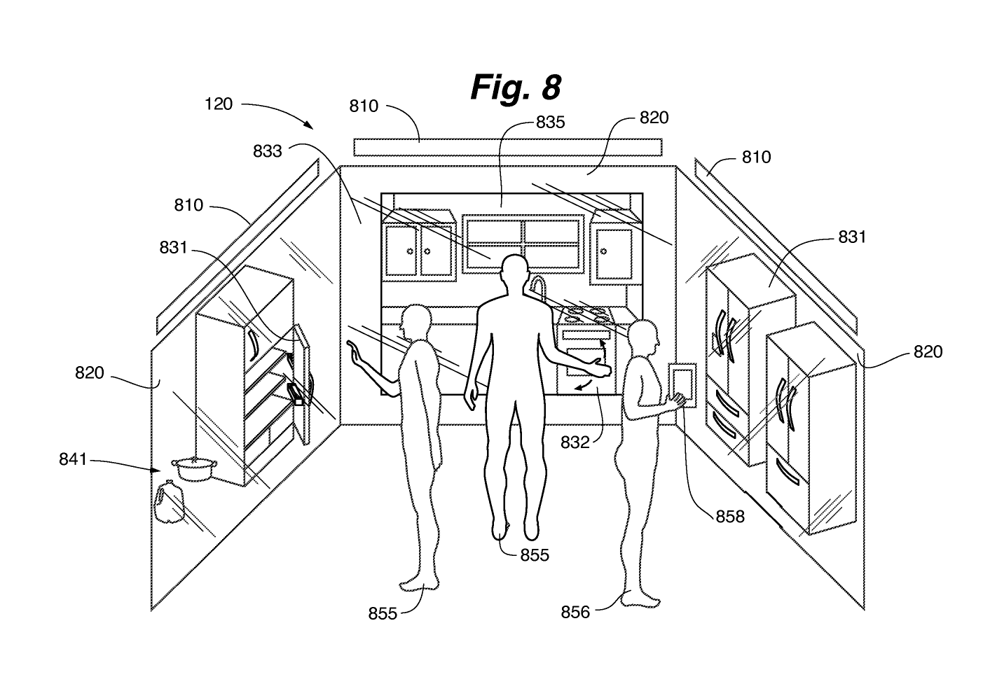

FIG. 8 shows an exemplary embodiment of display 120 of FIG. 1. In FIG. 8, the display 120 comprises one or more display screens 820 and one or more sensors 810. The sensors 810 may include motion sensors, 3D depth sensors, heat sensors, light sensors, pressure sensors, audio microphones, etc. Such sensors will be known and understood by one of ordinary skill in the art. Although sensors 810 are depicted in FIG. 8 as being overhead sensors, the sensors 810 could be placed in multiple locations around display 120. Sensors 810 could also be placed at various heights above the floor, or could be placed in the floor.

In a first section of screen 820 in FIG. 8, a customer 855 interacts with a 3D rendered product image 831 using natural motion gestures to manipulate the image 831. Interactions with product image 831 may use an animation simulating actual use of product 831. For example, by using natural gestures the customer 855 could command the display to perform animations such as opening and closing doors, pulling out drawers, turning switches and knobs, rearranging shelving, etc. Other gestures could include manipulating 3D rendered images of objects 841 and placing them on the product image 831. Other gestures may allow the user to manipulate the image 831 on the display 820 to virtually rotate the product, enlarge or shrink the image 831, etc.

In one embodiment a single image 831 may have multiple manipulation modes, such as rotation mode and animation mode. In this embodiment a customer 855 may be able to switch between rotation mode and animation mode and use a single type of gesture to represent a different image manipulation in each mode. For example, in rotation mode, moving a hand horizontally may cause the image to rotate, and in animation mode, moving the hand horizontally may cause an animation of a door opening or closing.

In a second section of screen 820, a customer 855 may interact with 3D rendered product images overlaying an image of a room. For example, the screen 820 could display a background photo image 835 of a kitchen. In one embodiment the customer 855 may be able to take a high-resolution digital photograph of the customer 855's own kitchen and send the digital photo to the display screen 820. The digital photograph may be stored on a customer's mobile device and sent to the display 120 via a wireless connection. A 3D rendered product image 832 could be manipulated by adjusting the size and orientation of the image 832 to fit into the photograph 835. In this way the customer 855 could simulate placing different products such as a dishwasher 832 or cabinets 833 into the customer's own kitchen. This virtual interior design could be extended to other types of products. For example, for a furniture retailer, the customer 855 could arrange 3D rendered images of furniture over a digital photograph of the customer 855's living room.

In a large-screen or multiple-screen display 120 as in FIG. 8, the system preferably can distinguish between different customers 855. In a preferred embodiment, the display 120 supports passing motion control of a 3D rendered image between multiple individuals 855-856. In one embodiment of multi-user interaction with display 120, the sensors 810 track a customer's head or face to determine where the customer 855 is looking. In this case, the direction of the customer's gaze may become part of the raw data that is interpreted as a gesture. For example, a single hand movement by customer 855 could be interpreted by the controller 240 differently based on whether the customer 855 was looking to the left side of the screen 820 or the right side of the screen 820. This type of gaze-dependent interactive control of 3D rendered product images on display 120 is also useful if the sensors 810 allow for voice control. A single audio voice cue such as “open the door” combined with the customer 855's gaze direction would be received by the controller 240 and used to manipulate only the part of the 3D rendered image that was within the customer 855's gaze direction.

In one embodiment, an individual, for example a store clerk 856, has a wireless electronic mobile device 858 to interact with the display 120. The device 858 may be able to manipulate any of the images 831, 835, 841 on display screen 820. If a plurality of interactive product displays 120 is located at a single location as in FIG. 8, the system may allow a single mobile device 858 to be associated with one particular display screen 820 so that multiple mobile devices can be used in the store 101. The mobile device 858 may be associated with the interactive display 120 by establishing a wireless connection between the mobile device and the interactive display 120. The connection could be a Wi-Fi connection, a Bluetooth connection, a cellular data connection, or other type of wireless connection. The display 120 may identify that the particular mobile device 858 is in front of the display 120 by receiving location information from a geographic locator within device 858, which may indicate that the mobile device 858 is physically closest to a particular display or portion of display 120.

Data from sensors 810 can be used to facilitate customer interaction with the display screen 820. For example, for a particular individual 855 using the mobile device 858, the sensors 810 may identify the customer 855's gaze direction or other physical gestures, allowing the customer 855 to interact using both the mobile device 858 and the user's physical gestures such as arm movements, hand movements, etc. The sensors 810 may recognize that the customer 855 is turned in a particular orientation with respect to the screen, and provide gesture and mobile device interaction with only the part of the display screen 820 that the user is oriented toward at the time a gesture is performed.

It is contemplated that other information could be displayed on the screen 820. For example, product descriptions, product reviews, user information, product physical location information, and other such information could be displayed on the screen 820 to help the customer view, locate, and purchase products for sale.

### Smart Wearable Mobile Devices 900

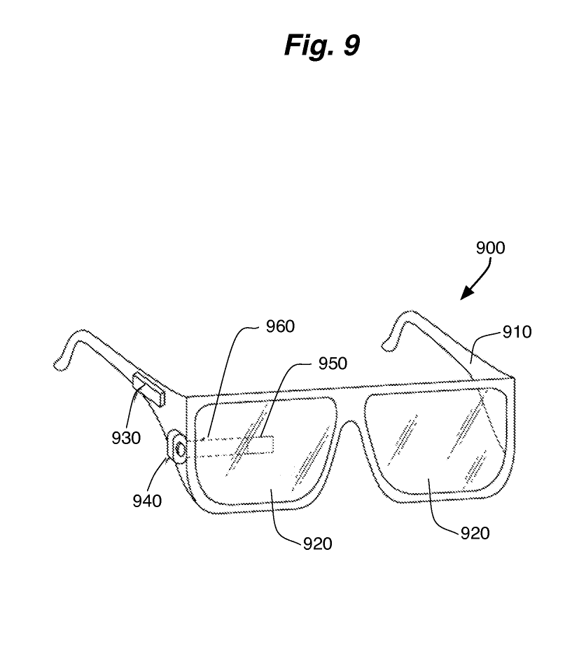

FIG. 9 shows a smart wearable mobile device 900 that may be utilized by a store clerk 137 as mobile device 139. In particular, FIG. 9 shows a proposed embodiment of Google Glass by Google Inc., as found in U.S. Patent Application Publication 2013/0044042. In this embodiment, a frame 910 holds two lens elements 920. An on-board computing system 930 handles processing for the device 900 and communicates with nearby computer networks, such as private network 205 or the Internet 210. A video camera 940 creates still and video images of what is seen by the wearer of the device 900, which can be stored locally in computing system 930 or transmitted to a remote computing device over the connected networks. A display 950 is also formed on one of the lens elements 920 of the device 900. The display 950 is controllable via the computing system 930 that is coupled to the display 950 by an optical waveguide 960. Google Glass has been made available in limited quantities for purchase from Google Inc. This commercially available embodiment is in the form of smart eyewear, but contains no lens elements 920 and therefore the frame is designed to hold only the computing system 930, the video camera 940, the display 950, and various interconnection circuitry 960.

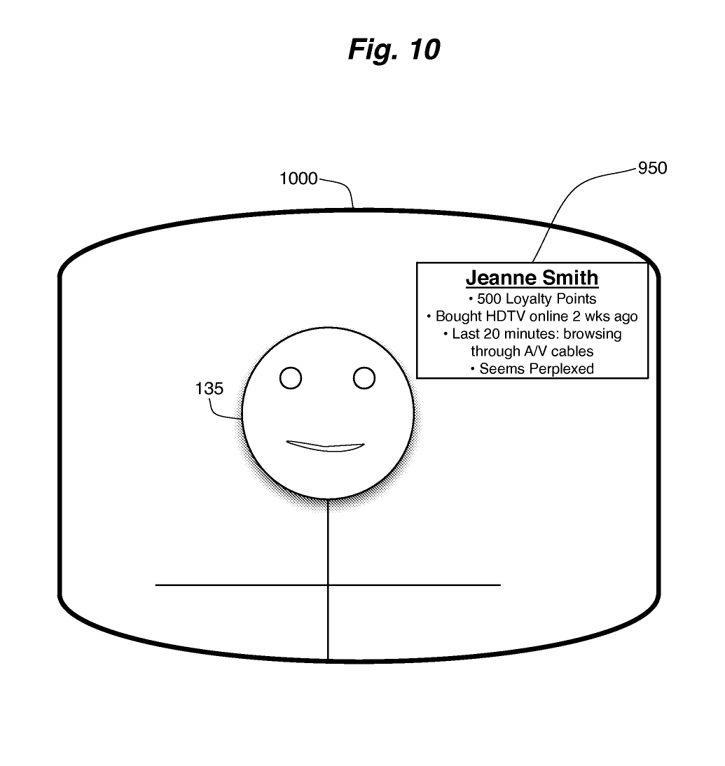

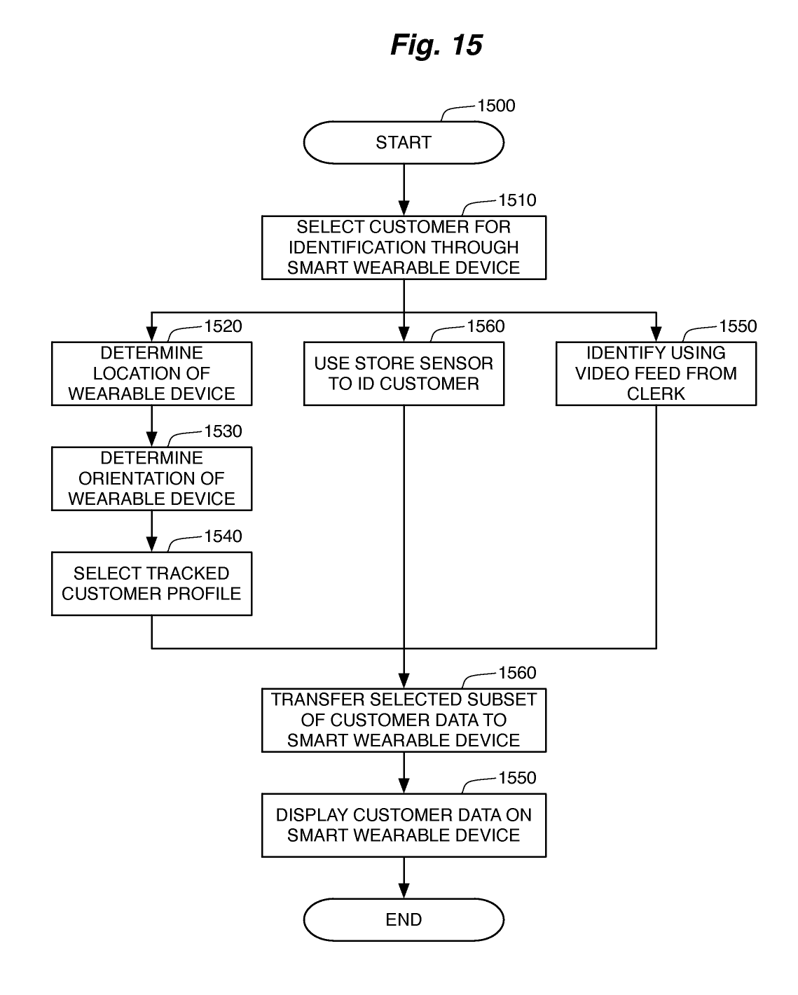

FIG. 10 shows an example view 1000 through the wearable mobile device 900 that is worn by the store clerk 137 while looking at customer 135. As is described in more detail in connection with FIG. 15 below, the store clerk 137 is able to view a customer 135 through the device 900 and request identification and information about that customer 135. Based on the location of the clerk 137, the orientation of the clerk 137, and the current location of the customer 135, the store sensor server 230 will be able to identify the customer. Other identification techniques are described in connection with FIG. 15. When the customer 135 has been identified, information relevant to the customer is downloaded to the device 900. This information is shown displayed on display 950 in FIG. 10. In this example, the server 230 provides:
1) the customer's name,
2) the customer's status in the retailer's loyalty program (including available points to be redeemed),
3) recent, major on-line and in-store purchases,
4) the primary activity of the customer 135 that has been tracked during this store visit, and
5) the emotional reaction recorded during the primary tracked activity.
   In other embodiments, the server 230 could provide a customer photograph, and personalized product recommendations and offers for products and services based upon the customer's purchase and browsing history. Based on the information shown in display 950, the store clerk 137 will have a great deal of information with which to help the customer 135 even before the customer 135 has spoken to the clerk.

In other embodiments, the store sensor server 230 will notify a clerk 137 that a customer 134 located elsewhere in the store needs assistance. In this case, the server 230 may provide the following information to the display 950:
1) the location of the customer within the store,
2) the customer's name,
3) primary activity tracked during this store visit, and
4) the emotional reaction recorded during the primary tracked activity.
   The clerk receiving this notification could then travel to the location of the customer needing assistance. The store sensor server 230 could continue tracking the location of the customer 134 and the clerk 137, provide the clerk 137 updates on where the customer 134 is located, and finally provide confirmation to the clerk 137 when they are addressing the customer 134 needing assistance.

In still other embodiments, the clerk could use the wearable device 900 to receive information about a particular product. To accomplish this, the device 900 could transmit information to the server 230 to identify a particular product. The camera 950 might, for instance, record a bar code or QR code on a product or product display and send this information to the server 230 for product identification. Similarly, image recognition on the server 230 could identify the product found in the image transmitted by the camera 950. Since the location and orientation of the device 900 can also be identified using the techniques described herein, the server 230 could compare this location and orientation information against a floor plan/planogram for the store to identify the item being viewed by the clerk. Once the product is identified, the server 230 could provide information about that product to the clerk through display 950. This information would be taken from the product database 500, and could include:

1) the product's name,

2) a description and a set of specifications for the product,

3) inventory for the product at the current store,

4) nearby store inventory for the product,

5) online availability for the product,

6) a review of the product made by the retailer's customers,

7) extended warranty pricing and coverage information,

8) upcoming deals on the product, and

9) personalized deals for the current (previously identified) customer.

### Method for Determining Reaction to 3D Images

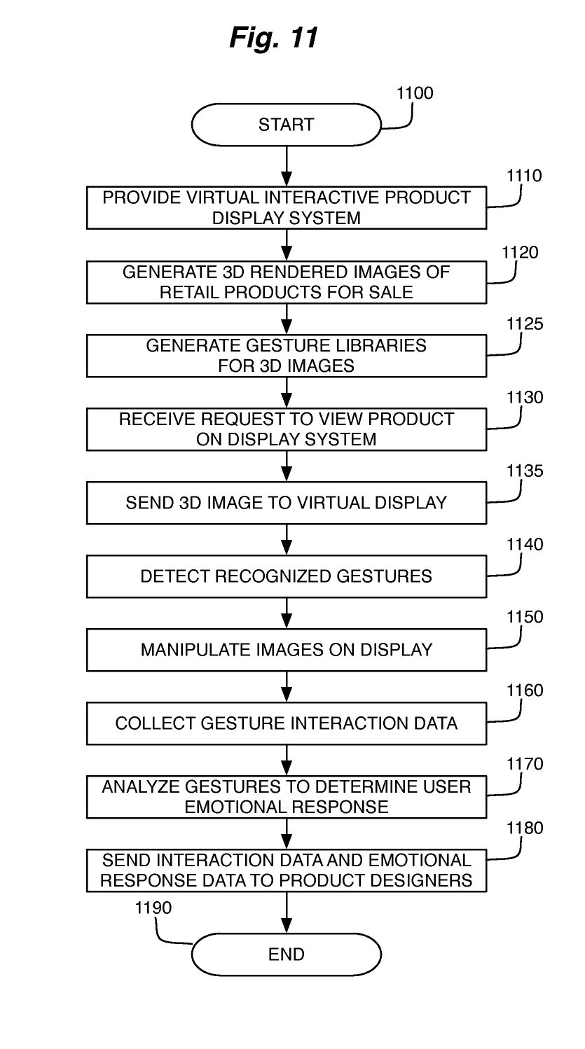

FIGS. 11-13 and 15 are flow charts showing methods to be used with various embodiments of the present disclosure. The embodiments of the methods disclosed in these Figures are not to be limited to the exact sequence described. Although the methods presented in the flow charts are depicted as a series of steps, the steps may be performed in any order, and in any combination. The methods could be performed with more or fewer steps. One or more steps in any of the methods could also be combined with steps of the other methods shown in the Figures.

FIG. 11 shows the method 1100 for determining customer emotional reaction to 3D rendered images of products for sale. In step 1110, a virtual interactive product display system is provided. The interactive display system may be systems described in connection with FIG. 8. The method 1100 may be implemented in a physical retail store 101, but the method 1100 could be adapted for other locations, such as inside a customer's home. In that case, the virtual interactive display could comprise a television, a converter having access to a data network 210 (e.g., a streaming media player or video game console), and one or more video cameras, motion sensors, or other natural-gesture input devices enabling interaction with 3D rendered images of products for sale.

In step 1120, 3D rendered images of retail products for sale are generated. In a preferred embodiment each image is generated in advance and stored in a products database 500 along with data related to the product represented by the 3D image. The data may include a product ID, product name, description, manufacturer, etc. In step 1125 gesture libraries are generated. Images within the database 500 may be associated with multiple types of gestures, and not all gestures will be associated with all images. For example, a “turn knob” gesture would likely be associated with an image of an oven, but not with an image of a refrigerator.

In step 1130, a request to view a 3D product image on display 120 is received. In response to the request, in step 1135 the 3D image of the product stored in database 500 is sent to the display 120. In step 1140, sensors 246 at the display 120 recognize gestures made by the customer. The gestures are interpreted by controller computer 240 as commands to manipulate the 3D images on the display screen 242. In step 1150 the 3D images are manipulated on the display screen 242 in response to receiving the gestures recognized in step 1140. In step 1160 the gesture interaction data of step 1140 is collected. This could be accomplished by creating a heat map of a customer 135's interaction with display 120. Gesture interaction data may include raw sensor data, but in a preferred embodiment the raw data is translated into gesture data. Gesture data may include information about the user's posture and facial expressions while interacting with 3D images.

In step 1170, the gesture interaction data is analyzed to determine user emotional response to the 3D rendered images. The gesture interaction data may include anatomical parameters in addition to the gestures used by a customer to manipulate the images. The gesture data captured in step 1160 is associated with the specific portion of the 3D image that the customer 135 was interacting with when exhibiting the emotional response. For example, the customer 135 may have interacted with a particular 3D image animation simulating a door opening, turning knobs, opening drawers, placing virtual objects inside of the 3D image, etc. These actions are combined with the emotional response of the customer 135 at the time. In this way it can be determined how a customer 135 felt about a particular feature of a product.

The emotional analysis could be performed continuously as the gesture interaction data is received, however, the gesture sensors will generally collect an extremely large amount of information. Because of the large amount of data, the system may store the gesture interaction data in data records 425 on a central server and process the emotional analysis at a later time.

In step 1180, the analyzed emotional response data is provided to a product designer. For example, the data may be sent to a manufacturer 290 of the product. Anonymous gesture data is preferably aggregated from many different customers 135. The manufacturer can use the emotional response information to determine which product features are liked and disliked by consumers, and therefore improve product design to make future products more user-friendly. The method ends at step 1190.

In one embodiment the emotional response information could be combined with customer-identifying information. This information could be used to determine whether the identified customer liked or disliked a product. The system could then recommend other products that the customer might like. This embodiment would prevent the system from recommending products that the customer is not interested in.

### Method for Analyzing Data

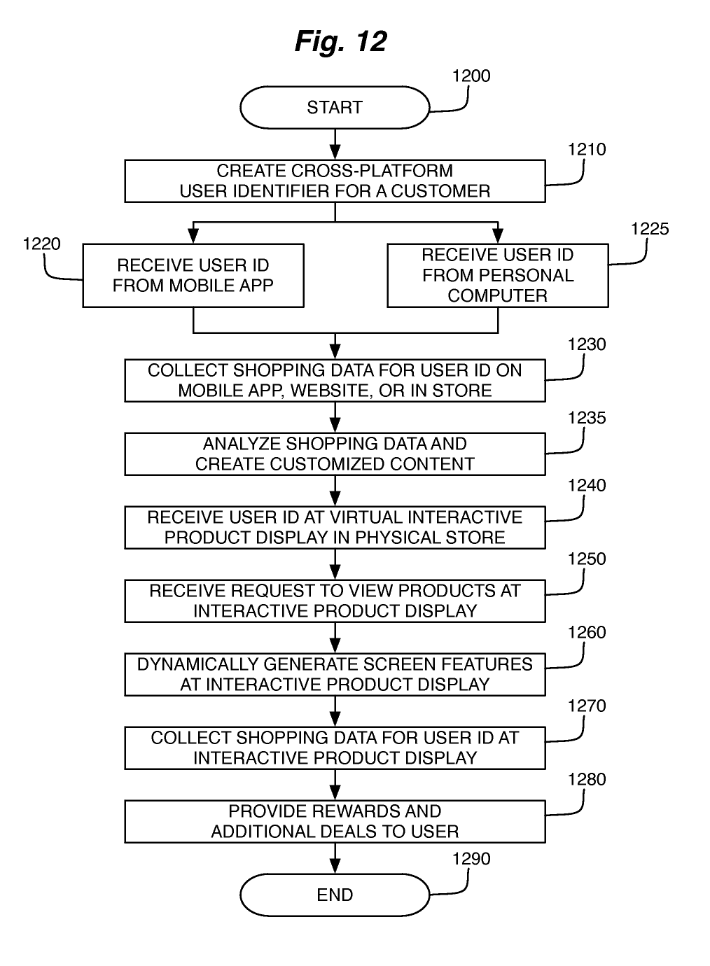

FIG. 12 is a flow chart demonstrating a method for creating customized content and analyzing shopping data for a customer. In step 1210, a cross-platform user identifier is created for a customer. This could be a unique numerical identifier associated with the customer. In alternative embodiments, the user ID could be a loyalty program account number, a credit card number, a username, an email address, a phone number, or other such information. The user ID must be able to uniquely identify a customer making purchases and shopping across multiple retail platforms, such as mobile, website, and in-store shopping.

Creating the user ID requires at least associating the user ID with an identity of the customer 135, but could also include creating a personal information profile 650 with name, address, phone number, credit card numbers, shopping preferences, and other similar information. The user ID and any other customer information associated with the customer 135 are stored in customer information database 450.

In a preferred embodiment the association of the user ID with a particular customer 135 could happen via any one of a number of different channels. For example, the user ID could be created at the customer mobile device 136, the mobile app 263, the personal computer 222, in the physical retail store 101 at POS 150, the kiosk 160, at the display 120, or during the customer consultation with clerk 137.

In step 1220, the user ID may be received in mobile app 263. In step 1225, the user ID may be received from personal computer 222 when the customer 135 shops on the retailer's website through server 220. These steps 1220 and 1225 are exemplary only, and serve only to show that multiple sources could be used to receive the user ID.

In step 1230, shopping behavior, browsing data, and purchase data are collected for shopping behavior on mobile app 263, the e-commerce web store, or in person as recorded by the POS server 225 or the store sensor server 230. In step 1235 the shopping data is analyzed and used to create customized content. The customized content could include special sales promotions, loyalty rewards, coupons, product recommendations, and other such content.

In step 1240, the user ID is received at the virtual interactive product display 120. In step 1250 a request to view products is received, which is described in more detailed in the incorporated patent application. In step 1260, screen features are dynamically generated at interactive display 1240. For example, the dynamically generated screen features could include customized product recommendations presented on display 242; a welcome greeting with the customer's name; a list of products that the customer recently viewed; a display showing the number of rewards points that the customer 135 has earned; or a customized graphical user interface “skin” with user-selected colors or patterns. Many other types of customer-personalized screen features are contemplated and will be apparent to one skilled in the art.

In step 1270, shopping behavior data is collected at the interactive product display 120. For example, information about the products viewed, the time that the customer 135 spent viewing a particular product, and a list of the products purchased could be collected. In step 1280, the information collected in step 1270 is used to further provide rewards, deals, and customized content to the customer 135. The method ends at step 1290.

Method for Collecting Customer Data within Store

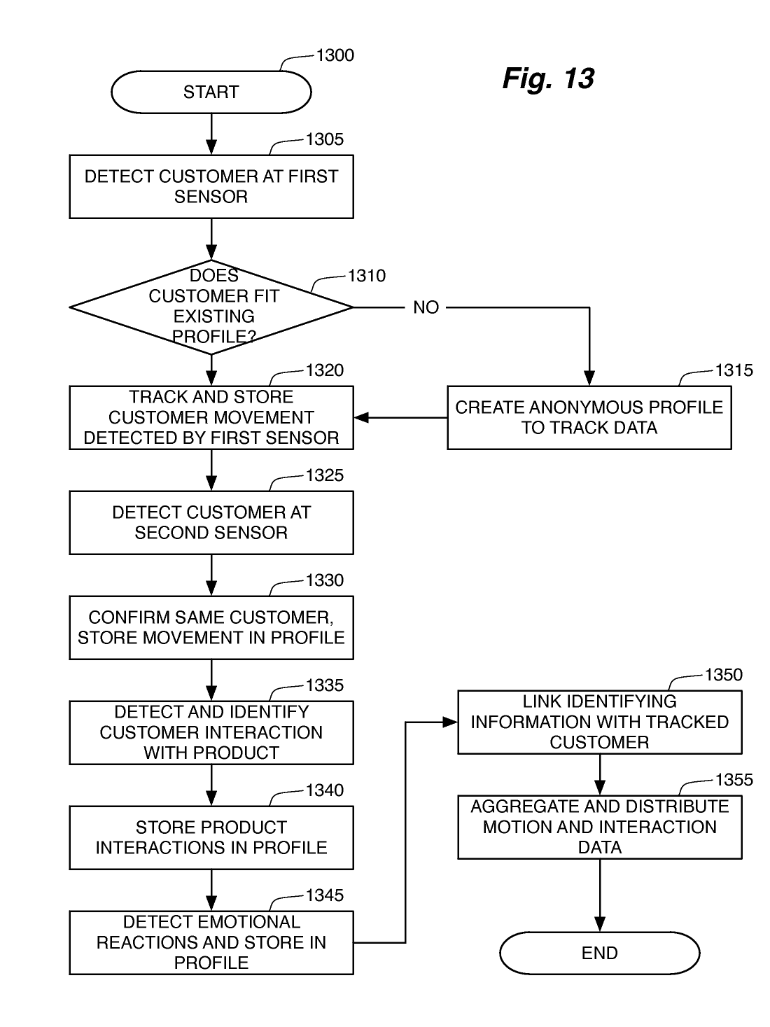

FIG. 13 shows a method 1300 for collecting customer data analytics in a physical retail store using store sensors 170 and store sensor server 230. In step 1305, a sensor 170 detects a customer 134 at a first location. The sensor 170 may be a motion sensor, video camera, or other type of sensor that can identify anatomical parameters for a customer 134. For example, a customer 134 may be recognized by a facial recognition, or by collecting a set of data related to the relative joint position and size of the customer 134's skeleton. Assuming that anatomical parameters are recognized that are sufficient to identify an individual, step 1310 determines whether the detected parameters for the customer 134 matches an existing profile stored within the store sensor server 230. In one embodiment, the store sensor server 230 has access to all profiles that have been created by monitoring customers through the sensors 170 in store 101. In another embodiment, a retailer may have multiple store locations 101, and the store sensor server 230 has access to all profiles created in any of the store locations. As explained above, a profile contains sufficient anatomical parameters, as detected by the sensors 170, so as to be able to identify that individual 134 when they reenter the store for a second visit. If step 1310 determines that the parameters detected in step 1305 match an existing profile, that profile will be used to track the customer's movements and activities during this visit to the retail store 101. If step 1310 does not match the customer 134 to an existing profile, a new profile is created at step 1315. Since this customer 134 is not known in this event, this new profile is considered an anonymous profile.

The previous paragraph assumes that the sensors 170 identify customer 134 through the user of anatomical parameters that are related to a customer's body, such as facial or limb characteristics. Steps 1305 and 1310 can also be performed using sensors 170 that detect digital signatures or signatures from devices carried by the customer 134. For example, a customer's cellular phone may transmit signals containing a unique identifier, such as a Wi-Fi signal that emanates from a cellular phone when it attempts to connect to a Wi-Fi service. Technology to detect and identify customers using these signals is commercially available through Euclid of Palo Alto, Calif. Alternatively, the sensors 170 could include RFID readers that read RFID tags carried by an individual. The RFID tags may be embedded within loyalty cards that are provided by the retailer to its customers. In this alternative embodiment, steps 1305 and 1310 are implemented by detecting and comparing the digital signatures (or other digital data) received from an item carried by the individual against the previously received data found in the profiles accessed by the store sensor server 230.

At step 1320, the first sensor 170 tracks the customer's movement within the retail store 101 and then stores this movement in the profile being maintained for that customer 134. Some sensors may cover a relatively large area of the retail store 101, allowing a single sensor 170 to track the movement of customers within that area. Such sensors 170 will utilize algorithms that can distinguish between multiple customers that are found in the coverage area at the same time and separately track their movements. When a customer 134 moves out of the range of the first sensor 170, the customer may already be in range of, and be detected by, a second sensor 170, which occurs at step 1325. In some embodiments, the customer 134 is not automatically recognized by the second sensor 170 as being the same customer 134 detected by the first sensor at step 1305. In this embodiment, the second sensor 1381 must collect anatomical parameters or digital signatures for that customer 134 and compare this data against existing profiles, as was done in step 1310 for the first sensor. In other embodiments, the store sensor server 230 utilizes the tracking information from the first sensor to predict which tracking information on the second sensor is associated with the customer 134.

The anatomical parameters or digital signatures detected in steps 1305 and 1325 may be received by the sensors 170 as “snapshots.” For example, a first sensor 170 could record an individual's parameters just once, and a second sensor 170 could record the parameters once. Alternatively, the sensors 170 could continuously follow customer 134 as the customer 134 moves within the range of the sensor 170 and as the customer 134 moves between different sensors 170.

If the two sensors 170 separately collected and analyzed the parameters for the customer 134, step 1330 compares these parameters at the store sensor server 230 to determine that the customer 134 was present at the locations covered by the first and second sensors 170.

In step 1335, the sensors 170 recognize an interaction between the customer 134 and a product 110 at a given location. This could be as simple as recognizing that the customer 134 looked at a product 110 for a particular amount of time. The information collected could also be more detailed. For example, the sensors 170 could determine that the customer 134 sat down on a couch or opened the doors of a model refrigerator. The product 110 may be identified by image analysis using a video camera sensor 170. Alternatively, the product 110 could be displayed at a predetermined location with the store 101, in which case the system 100 would know which product 110 the customer 134 interacted with based on the known location of the product 110 and the customer 134. These recognized product interactions are then stored at step 1340 in the customer's visit profile being maintained by the store sensor server 230.

In step 1345, the customer's emotional reactions to the interaction with the product 110 may be detected. This detection process would use similar methods and sensors as was described above in connection with FIG. 11, except that the emotional reactions would be determined based on data from the store sensors 170 instead of the virtual display sensors 246, and the analysis would be performed by the store sensor server 230 instead of the virtual display controller 240. The detected emotional reactions to the product would also be stored in the profile maintained by the store sensor server 230.

In step 1350, the method 1300 receives customer-identifying information that can be linked with the customer 134. Customer identifying information is information that explicitly identifies the customer, such as the customer's name, user identification number, address, or credit card account information. For example, the customer 134 could log into their on-line account with the retailer using the store kiosk 160, or could provide their name and address to a store clerk for the purpose of ordering products or services who then enters that information into a store computer system. Alternatively, the customer 134 could provide personally-identifying information at a virtual interactive product display 120. In one embodiment, if the customer chooses to purchase a product 110 at a POS 1820, the customer 134 may be identified based on purchase information, such as a credit card number or loyalty rewards number. This information may be received by the store sensor server 230 through the private network 205 from the virtual product display 120, the e-commerce web server 220, or the point-of-sale server 225.

The store sensor server 230 must be able to link the activity that generated the identifying information with the profile for the customer 134 currently being tracked by the sensors 170. To accomplish this, the device that originated the identifying information must be associated with a particular location in the retail store 101. Furthermore, the store sensor server 230 must be informed of the time at which the identifying information was received at that device. This time and location data can then be compared with the visit profile maintained by the store sensor server 230. If, for example, only one customer 134 was tracked as interacting with the kiosk 160 or a particular POS terminal when the identifying information was received at that device, then the store server 230 can confidently link that identifying information (specifically, the customer record containing that information in the customer database 450) with the tracked profile for that customer 134. If that tracked profile was already linked to a customer record (which may occur on repeat visits of this customer 134), this link can be confirmed with the newly received identifying information at step 1350. Conflicting information can be flagged for further analysis.

In step 1355, the system repeats steps 1305-1350 for a plurality of individuals within the retail store 101, and then aggregates that interaction data. The interaction data may include sensor data showing where and when customers moved throughout the store 101, or which products 110 the customers were most likely to view or interact with. The information could identify the number of individuals at a particular location; information about individuals interacting with a virtual display 120; information about interactions with particular products 110; or information about interactions between identified store clerks 137 and identified customers 134-135. This aggregated information can be shared with executives of the retailer to guide the executives in making better decisions for the retailer, or can be shared with manufacturers 290 to encourage improvements in product designs based upon the detected customer interactions with their products. The method 1300 then ends.

### Method for Assisting Employee Customer Interactions

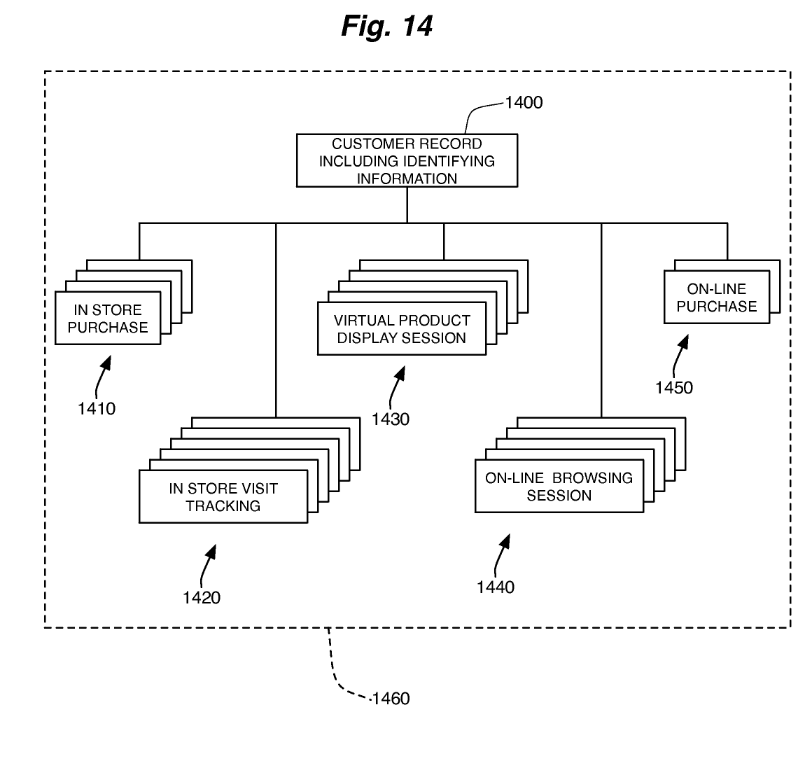

One benefit of the retailer system 100 is that a great deal of information about a customer is collected, which can then be used to greatly improve the customer's interactions with the retailer. FIG. 14 schematically illustrates some of this data. In particular, a customer record 1400 from the customer database 450 contains personal information about the user including preferences and payment methods. This basic customer data 1400 is linked to in-store purchase records 1410 the reflect in-store purchases that have been made by this customer. Linking purchase data accumulated by the POS server 225 to customer records can be accomplished in a variety of ways, including through the use of techniques described in U.S. Pat. No. 7,251,625 (issued Jul. 31, 2007) and U.S. Pat. No. 8,214,265 (issued Jul. 3, 2012). In addition, each visit by the customer to a physical retail store location can be identified by the store sensor server 230 and stored as data 1420 in association with the client identifier. Each interaction 1430 with the virtual product display 120 can also be tracked as described above. These data elements 1400, 1410, 1420, and 1430 can also be linked to browsing session data 1440 and on-line purchase data 1450 that is tracked by the e-commerce web server 220. This creates a vast reservoir 1460 of information about a customer's purchases and behaviors in the retailer's physical stores, e-commerce website, and virtual product displays.

The flowchart shown in FIG. 15 describes a method 1500 that uses this data 1460 to improve the interaction between the customer 135 and the retail store clerk 137. The method starts at step 1510 with the clerk 137 requesting identification of a customer 135 through their smart, wearable device such as smart eyewear 900. When the request for identification is received, there are at least three separate techniques through which the customer can be identified.

In the first technique, a server (such as the store sensor server 230) identifies the location of the clerk 137 and their wearable device 900 within the retail store 101 at step 1520. This can be accomplished through the tracking mechanisms described above that use the store sensors 170. Alternatively, step 1520 can be accomplished using a store sensor 170 that can immediately identify and locate the clerk 137 through a beacon or other signaling device carried by the clerk or embedded in the device 900, or by requesting location information from the locator 291 on the clerk's device 900. Next, at step 1530, the server 230 determines the point of view or orientation of the clerk 137. This can be accomplished using a compass, gyroscope, or other orientation sensor found on the smart eyewear 900. Alternatively, the video signal from camera 940 can be analyzed to determine the clerk's point of view. A third technique for accomplishing step 1530 is to examine the information provided by store sensors 170, such as a video feed showing the clerk 137 and the orientation of the clerk's face, to determine the orientation of the clerk 137. Next, at step 1540 the server 230 examines the tracked customer profiles to determine which customer is closest to, and in front of, the clerk 137. The selected customer 135 will be the customer associated with that tracked customer profile.

In the second customer identification technique, the store sensor server 230 uses a sensor 170 to directly identify the individual 135 standing closest to the clerk 137. For example, the sensors 170 may be able to immediately identify the location of the clerk by reading digital signals from the clerk's phone, smart eyewear 900, or other mobile device, and then look for the closest individual that also is emitting readable digital signals. The sensors 170 may then read those digital signals from a cell phone or other mobile device 136 carried by the customer 135, look up those digital parameters in a customer database, and then directly identify the customer 135 based on that lookup.

In the third customer identification technique, a video feed from the eyewear camera 940 is transmitted to a server, such as store sensor server 230. Alternatively, the eyewear camera 940 could transmit a still image to the server 230. The server 230 then analyzes the physical parameters of the customer 135 shown in that video feed or image, such as by using known facial recognition techniques, in order to identify the customer.

Alternative customer identification techniques could also be utilized, although these techniques are not explicitly shown in FIG. 15. For instance, the sales clerk could simply request that the user self-identify themselves, such as by providing their name, credit card number, or loyalty club membership number to the clerk. This information could be spoken into or other inputted into the clerk's mobile device 139 and transmitted to the server for identification purposes. In one embodiment, the clerk need only look at the card using the smart eyewear 900, allowing the eyewear camera 940 to image the card. The server would then extract the customer-identifying information directly from the image of that card.

Regardless of the identification technique used, the method continues at step 1560 with the server gathering the data 1460 available for that customer, choosing a subset of that data 1460 for sharing with the clerk 137, and then downloading that subset to the smart eyewear 900. In FIG. 10, that subset of data included the customer's name, their status in a loyalty program, recent large purchases made (through any purchase mechanism), their primary in-store activity during this visit, and their last interpreted emotional reaction as sensed by the system 200. This data is then displayed to the clerk 137 through the smart eyewear 900, and the method ends.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method comprising:
a) receiving, at a server computer and from smart eyewear worn by a clerk in a retail store of a retailer, a request to identify a customer;
b) at the server computer, identifying the customer by associating the customer with a record in a customer database;
c) at the server computer, selecting data about the customer from the customer database;
d) transmitting, from the server computer, the selected data for presentation to the clerk via a display integrated into the smart eyewear.

2. The method of claim 1, wherein the step of identifying the customer comprises receiving a video feed showing a customer's face from the smart eyewear and applying facial recognition to the customer's face.

3. The method of claim 1, wherein the step of identifying the customer comprises using a store sensor located proximal to the customer to read digital data from a device carried by the customer.

4. The method of claim 1, wherein the step of identifying the customer further comprises:
i) receiving from the smart eyewear customer identifying data input at the eyewear, and
ii) comparing the customer identifying data with the record in the customer database.

5. The method of claim 4, wherein the customer identifying data is an image of a card carried by the customer.

6. The method of claim 1, further comprising:
e) at the server computer, receiving sensor data from a plurality of store sensors;
f) at the sever computer, using the sensor data to track a movement path of the customer through the retail store; and
g) at the server computer, storing the movement path of the customer.

7. The method of claim 6, further comprising:
h) at the server computer, receiving notification of a customer identification event, the customer notification including:
i) a time for the customer notification event,
ii) a location within the retail store for the customer notification event, and
iii) a customer identifier for the customer notification event; and
i) at the server computer, matching the customer identification event to the movement path for the customer by comparing the time and location of the customer notification event to data in the movement path of the customer.

8. The method of claim 6, wherein the step of identifying the customer further comprises:
i) receiving, at the server computer, a customer location for the customer;
ii) matching the customer location to the movement path for the customer;
iii) identifying a customer identifier associated with the movement path.

9. The method of claim 6, wherein the selected data comprises data acquired from the plurality of store sensors relating to the movement path of the customer.

10. The method of claim 1, wherein the selected data comprises a customer name.

11. The method of claim 10, wherein the selected data further comprises data selected from a set of data comprising:
i) a status of the customer in a retailer loyalty program, and
ii) recent purchases of the customer at the retailer.

12. A system comprising:
a) smart eyewear having:
i) an eyewear processor,
ii) tangible, non-transitory eyewear memory containing programming for the eyewear processor,
iii) an imaging device, and
iv) a display device;
b) a server computer having:
i) a server processor
ii) tangible, non-transitory server memory containing programming for the server processor and a customer database;
c) eyewear programming on the eyewear memory instructing the eyewear processor to:
i) transmit a request to identify a customer to the server computer,
ii) receive customer information for the customer from the server computer, and
iii) display the customer information on the display device; and
d) server programming on the server memory instructing the server processor to:
i) receive the request to identify the customer from the smart eyewear;
ii) identify a customer identifier for the customer;
iii) use the customer identifier to retrieve the customer information for the customer from the customer database; and
iv) transmit the customer information to the smart eyewear.

13. The system of claim 12, further comprising:
e) a plurality of sensors located in a retail store, the plurality of sensors capable of sensing identifying information for the customer as the customer passes through the retail store,
wherein the sensors transmit the identifying information to the server computer,
further wherein the server computer uses the identifying information to identify the customer identifier for the customer.

14. A method comprising:
a) at a server computer, receiving sensor data from a plurality of store sensors in a retail store;
b) at the server computer, using the sensor data to track a movement path of a customer through the retail store;
c) at the server computer, storing the movement path of the customer;
d) at the server computer, receiving notification of a customer identification event, the customer notification event including:
i) a time for the customer notification event,
ii) a location within the retail store for the customer notification event, and
iii) a customer identifier for the customer notification event; and
e) at the server computer, matching the customer identification event to the movement path for the customer by comparing the time and location of the customer notification event to data in the movement path of the customer.

15. A method comprising:
a) at a first sensor, detecting personally identifying information concerning a customer within a retail store;
b) at a first computer, receiving the personally identifying information from the first sensor;
c) at the first computer, identifying a customer record in a customer database utilizing the received personally identifying information;
d) at a plurality of second sensors, detecting the personally identifying information at a plurality of locations in the retail store;
e) at the first computer, using data from the plurality of second sensors to track a movement path of the customer at the retail store;
f) at the first computer, receiving a request from a clerk mobile device to identify the customer;
g) at the first computer, identifying a current location for the customer;
h) at the first computer, using the current location for the customer to identify the movement path of the customer and identify the customer record for the customer;
i) at the first computer, transmitting data from the customer record to the clerk mobile device.

16. The method of claim 15, wherein the first sensor detects personally identifying information by detecting digital data transmitted from a device held by the customer.

17. The method of claim 15, wherein the first sensor detects personally identifying information by gathering facial image data for the customer.

18. The method of claim 15, wherein the clerk mobile device is a tablet computer, and the customer record data is displayed on a screen of the tablet computer.

19. The method of claim 15, wherein the clerk mobile device is a pair of smart eyewear containing a display, and the customer record data is presented on the display of the smart eyewear.

20. The method of claim 15, wherein the plurality of second sensors detect interactions between the customer and a product in the retail store, further wherein the first computer stores the product interactions in association with the customer record in the customer database.

21. The method of claim 20, wherein the plurality of second sensors detect an emotional reaction between the customer and the product, further wherein the first computer stores the emotional reaction to the product in association with the customer record in the customer database.
